(19) United States
(12) Patent Application Publication
(10) Pub. No.: US 2002/0089667 A1
(43) Pub. Date: Jul. 11, 2002

(54) Spectrometer with automatic referencing

(76) Inventor: Hanspeter Kellerhals, Uster (CH)

Correspondence Address: SHOEMAKER AND MATTARE, LTD., 2001 Jefferson Davis Highway, Crystal Plaza Building 1 - Suite 1203, Arlington, VA, 22202, US

(21) Appl. No.: 10/035,184

(22) Filed: Jan. 4, 2002

(30) Foreign Application Priority Data
Jan. 5, 2001 (EP) 01810011.5

(51) Int. Cl. G01J 3/42

(52) U.S. Cl. 356/325; 356/326

(57) ABSTRACT

A spectrometer (1) for reflection measurement contains a rotatable mirror arrangement (5) which is movable about an optical axis (21) between at least one measuring location (12) and a reference position (10), so that the measuring and reference conditions are largely identical. The rotatable mirror arrangement (5) and the reference sample(s) are arranged in a closed housing (13). The measuring samples (11) are placed on a receiving location (15) on the outer wall (14) of the housing (13). The spectrometer (1) with a rotatable mirror arrangement (5) may be applied for multiple referencing.

The invention relates to a spectrometer for the reflection measurement and to a method for referencing a spectrometer for the reflection measurement, with the features of the preamble of the independent patent claims.

The referencing is an important step in order to ensure the reproducibility of measuring results. With this a reference sample, a so-called standard reflector, is introduced into the light beam and under as identical as possible conditions as with the actual sample measurement a corresponding reference value, a reference curve or a reference spectrum is determined. Thus one may determine changes of apparatus constants which result e.g. with an advancing operational time or in dependence on the temperature, and the subsequent measurements may be corrected by corresponding coefficients determined from the reference measurement.

Spectrometers for reflection measurement and methods for referencing are already known. The adding of the reference sample into the light beam may at the same time be done manually by the operator. From the state of the art however there are also known spectrometers and methods for the automatic referencing.

Thus EP 502 495 shows a spectrometer with which before each measurement of an unknown sample there may be automatically carried out a reference measurement. For referencing, the broad-band spectrometer (400 nm to 2500 nm) contains a spade-shaped plate on which there are located a standard reflector for the NIR region and a standard reflector for the visible region. The plate is fastened in the housing on the drive shaft of a stepper motor. The stepper motor is located on the housing near to the exit opening of the light, wherein its drive shaft extends into the housing. The plate with the standard reflectors is pivoted into the light beam by the stepper motor. Subsequently a reference spectrum may be scanned over the whole band width, wherein the plate may be positioned so that either only one or however both standard reflectors are in the light beam. For the sample measurement the plate may again be pivoted out of the light beam so that the beam may be led through the exit opening in the housing onto an unknown sample.

U.S. Pat. No. 5,040,889 shows a spectrometer with combined NIR and UV/VIS light sources. With the different light sources fluorescing whiteners are tested. As a standard reflector there is applied a whitener which is deposited onto a plate. For carrying out reference measurements the plate is pivoted into the light beam. The plate is likewise moved with the help of a stepper motor which is accommodated in the housing. The reference measurements may before each measurement of an unknown sample be carried out at certain time intervals, in dependence of the temperature or sporadically.

A disadvantage of spectrometers known from the state of the art lies in the fact that the unknown measuring sample and the reference sample are introduced at different locations into the light beam which leads to different arrangements with respect to the statically held mirror arrangement. There result different conditions for determining reference and measuring spectra.

It is the object of the invention to avoid the disadvantages of that which is known, in particular thus to provide a spectrometer for reflection measurement with an automatic referencing and a method for the automatic referencing, with which the measuring and reference conditions are largely identical. Furthermore the calibration is to take place in the background and thus as much as possible relieve the user, and contaminations, in particular of the reference samples, are to be minimised as much as possible.

According to the invention this object is achieved with a spectrometer for reflection measurement and with a method for referencing a spectrometer for reflection measurement, with the features of the preamble of the independent patent claims.

A spectrometer according to the invention for reflection measurement with a mirror arrangement for deflecting a light beam and at least one reference sample is characterised in that the mirror arrangement is movable between at least one measuring position and at least one reference position, wherein the light beam in the measuring position is deflected onto a measuring sample and wherein the light beam in the reference position is deflected onto a reference sample. By way of a movable mirror arrangement it may be achieved that the reference sample(s) no longer need be applied or pivoted into the light beam and thus may be held stationary. Accordingly the reference material may be protected from external influences such as scratches, dust or other impurities. Furthermore the calibration with suitable auxiliary means may be particularly well automised.

It is particularly advantageous when the mirror arrangement between at least one measuring position and at least one reference position is rotatable about an optical axis which is defined by the direction of the incident light beam.

By way of the rotation of the mirror arrangement between a measuring position and a reference position it is achieved that the measuring and calibration conditions are largely identical. Advantageously the mirror arrangement with this in the known manner comprises a base as well as at least one first mirror for deflecting the light beam incident from a light source onto a measuring sample in the measuring position or onto a reference sample in a reference position, as well as at least one second mirror for deflecting the light beam incident from a measuring sample in a measuring position or from a reference sample in a reference position onto a detector. According to the invention thus the path of the light beam in the measuring and reference position is identical.

As a mirror in the context of the invention in particular planar mirrors or focussing mirrors are particularly well suitable.

In a particularly preferred embodiment example the mirror arrangement in the measuring position is rotated by 90° with respect to the reference position.

Advantageously at least the mirror arrangement and the reference sample(s) are arranged in a closed housing. Thus there is provided an inner space which effectively protects the components of the spectrometer such as the optic and reference sample which are extremely sensitive with respect to external influences such as dust, particles, contaminations. A closed housing for protecting the sensitive apparatus parts can then be realised particularly well when the housing in its outer wall contains at least one receiving location for receiving a measuring sample. Thus during the normal operation of the spectrometer no engaging into the housing is necessary. The mirror arrangement and the reference sample(s) remain protected. The receiving location for receiving a measuring sample on the outer wall of the housing is at the same time advantageously formed such that in the measuring position the light beam may be deflected from the mirror arrangement onto the measuring sample on the outer wall of the housing.

If the distance d1 from the optical axis of the mirror arrangement to the measuring sample and the distance d2 from the optical axis of the mirror arrangement to the reference sample are identical, the light path in the measuring position and reference position is identical. There are thus achieved optically comparable conditions between the sample measurement and calibration which in total improves the quality and reproducibility of measuring results.

The spectrometer according to the invention may according to the field of application contain a NIR light source for measurements in the near infra-red range or a UV/VIS light source for measurements in the ultraviolet or visible range.

Within the context of the invention it is conceivable to use apparatus with an internal and external light source or also with light sources on the housing. In a particularly preferred embodiment example the light source is in the inside of the housing. Thus it is in particular achieved that also the light source may be optimally protected from contamination or mechanical loadings.

A further improvement of the quality and reproducibility of the measuring results is achieved when the spectrometer apart from a standard reference sample yet contains at least one further reference sample for the internal checking of the standard reference sample. As a standard reference sample in the context of the invention with this there is to be understood that reference sample which preferably is applied for determining reference spectra.

Preferred materials for the reference sample(s), or as standard reflectors are spectralons and other thermoplasts based of fluorocarbon, KBr powder, TiO₂ powder or polystyrene.

For checking the wavelength accuracy amongst other plexiglas or the salts of rare earths are suitable.

Of course also other reference materials may be used which have a sufficient reflectivity or characteristic sharp NIR absorption bands.

A further subject-matter of the invention is a method for referencing a spectrometer in the reflection measurement with a mirror arrangement for deflecting a light beam and at least one reference sample, wherein the mirror arrangement for referencing is moved into a reference position, in particular about the optical axis defined by the incident light beam and wherein by deflection of the light beam onto a reference sample a reference spectrum is evaluated.

It is particularly advantageous when the calibration may be carried out automatically at a predeterminable moment. This may be achieved in a known manner in that the rotational mechanism of the mirror arrangement is controlled via software with which the moment for the reference measurement may be suitably programmed. Thus it is conceivable before each measurement of a measuring sample in the measuring position to carry out a measurement of a reference sample in the reference position. Of course there are also conceivable reference measurements on account of certain time intervals or also in dependence on other parameters (temperature, etc.) which may be recorded via a suitable measuring arrangement.

In a particularly preferred method the mirror arrangement between a measuring position and a reference position is rotated by 90°. Of course also other arrangements of the reference samples and thus rotations about other rotational angles are possible.

The invention is hereinafter explained in more detail in embodiment examples by way of the drawings. There are shown in

FIG. 1 a schematic representation of a spectrometer according to the invention

FIG. 2a a schematic view of a rotatable mirror arrangement of a spectrometer according to the invention in the measurement position

FIG. 2b a schematic view of a rotatable mirror arrangement of a spectrometer according to the invention in the reference position

FIG. 3 a three-dimensional representation of a housing with a rotatable mirror arrangement of a spectrometer according to the invention

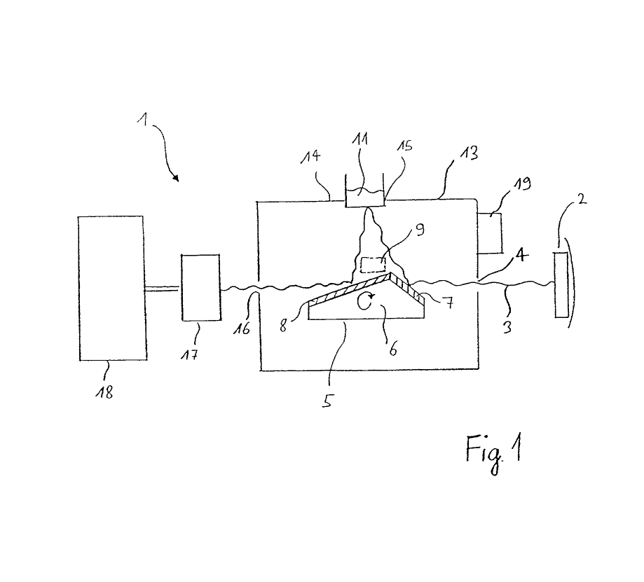

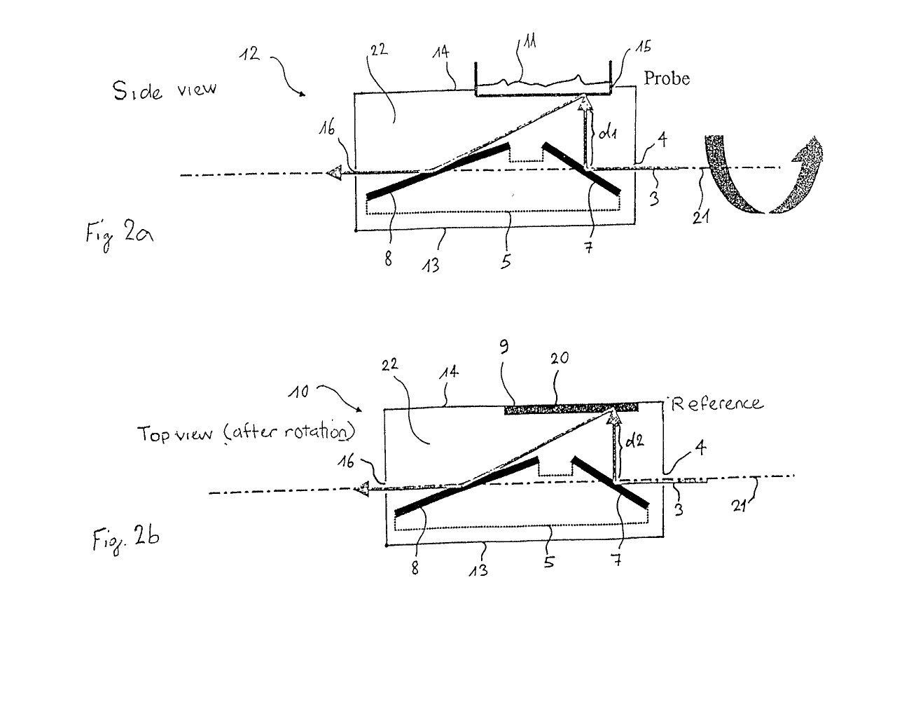

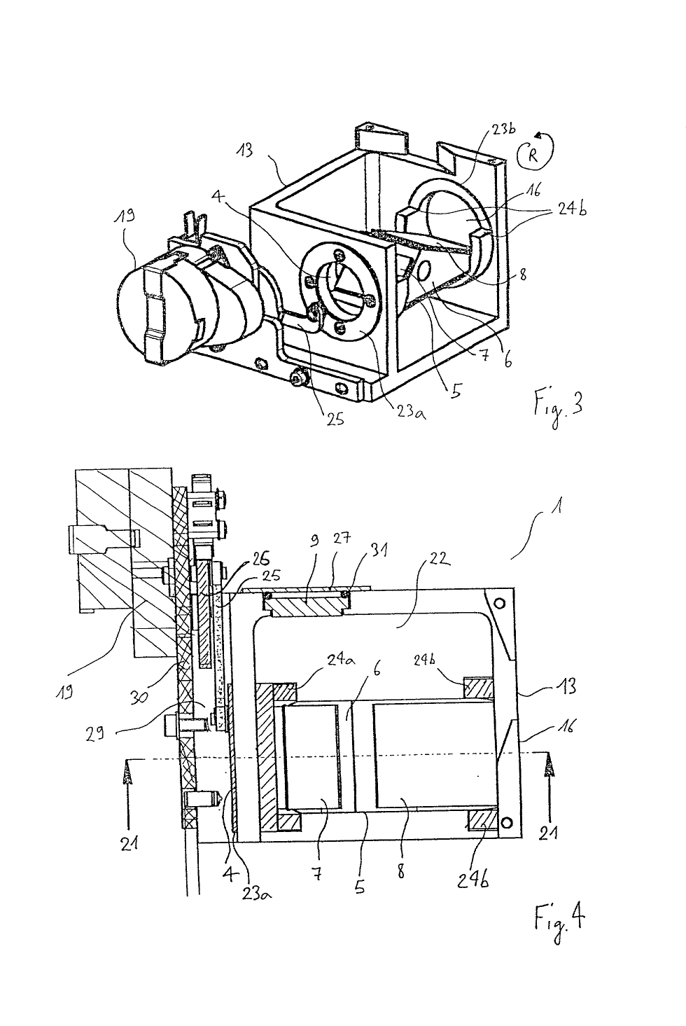

FIG. 4 a view of a housing with a rotatable mirror arrangement of a spectrometer according to the invention.

In FIG. 1 there is shown a spectrometer 1 according to the invention with a rotatable mirror arrangement 5. This example is only to schematically show one embodiment form of a spectrometer according to the invention. Of course numerous other arrangements are conceivable.

From the light source 2 a light beam 3 is led into the entry opening 4 of a housing 13. Before the entry into the housing 13 the beam in the known manner and with known auxiliary means may be prepared (parallelised, focussed, etc.). As a light source 2 various types of lamps are conceivable. Particularly preferred are NIR light sources and/or UV/VIS light sources. In the housing 13 there is located a mirror arrangement 5 with a base 6, with a first mirror 7 and with a second mirror 8. Likewise in the housing 13 there is located a reference sample 9 with reference material 20, which in FIG. 1 is only schematically indicated behind the mirror arrangement. On the outer wall 14 there is located a receiving location 15 for a measuring sample 11.

In FIG. 1 there is shown the mirror arrangement 5 in the measuring position 12. The light beam 3 passes through the entry opening 4 onto the first mirror 7 and here is deflected onto the measuring sample 11 in the receiving location 15 of the outer wall 14 of the housing 13. The light beam 3 reflected by the measuring sample 11 is led to the second mirror 8 and from here deflected to an exit opening 16 onto a detector 17. The mirror arrangement 5 is rotatable about the optical axis 21 which is defined by the direction of the incident and emergent light beam. The rotation may be effected with the help of a motor 19 which in the example according to FIG. 1 is attached to the outer wall 14 of the housing 13. By way of a rotation of the mirror arrangement 5 about 90° into a reference position 10 in the arrangement shown in FIG. 1 the light beam 3 is deflected onto the reference sample 9 with the reference material 20.

Arranged after the detector may be an arrangement for data processing and control. To this there may belong components such as amplifiers, A/D convertors, digital filters, electronic auxiliary means for generating Fourier transformations and for computing spectrograms. These auxiliary means are known and are not discussed here in more detail.

In FIGS. 2a and 2b there is shown the schematic mirror arrangement in the measuring position 12 (FIG. 2a) and in the reference position 10 (FIG. 2b) respectively. In the measuring position 12 the light beam 3 passes through the entry opening 4 of the housing 13 and reaches the first mirror 7 of the mirror arrangement 5 from where it is deflected onto the measuring sample 11 which is applied onto or inserted into the receiving location 15 on the outer wall 14 of the housing 13. The light beam 3 reflected by the measuring sample 11 goes onto the second mirror 8 of the mirror arrangement 5 and from here reaches the exit opening 16 where it leaves the closed inner space 22 of the housing 13.

By rotating the mirror arrangement 5 about the optical axis 21 the mirror arrangement 5 is brought into the reference position 10 (FIG. 2b). At the same time the light beam 3 is deflected by the first mirror 7 onto a reference sample 9 with reference material 20. In analogy to the measuring position (FIG. 2a) the reflected light beam 3 is deflected via the second mirror 8 to the exit opening 16.

From the FIGS. 2a and 2b it is evident that the optical path of the light beam 3 in the measurement position 12 and the reference position 10 is identical. In particular the distance d1 from the optical axis 21 of the mirror arrangement 5 to the measuring sample 11 as well as the distance d2 from the optical axis 21 of the mirror arrangement 5 to the reference sample 9 are identical. Thus the comparability of measuring and reference conditions is optimised, which leads to an improved quality and reproducibility. By way of the external supply of the measuring sample 11 onto the outer wall 14 of the housing 13 on the one hand and the arrangement of the reference sample 9 and the mirror arrangement 5 in the closed housing 13 on the other hand, it is effectively prevented that sensitive components such as reference sample 9 and mirror arrangement 5 in normal operation are mechanically (scratches) loaded and/or contaminated by way of external influences.

In the FIGS. 2a and 2b by way of example there is shown a rotation of the mirror arrangement 5 about 90° from the measuring position 12 to the reference position 10. Of course the mirror arrangement 5 may however be rotated by any angle about the optical axis 21 from a measuring position 12 to a reference position 10. With this it is particularly advantageous when the reference sample(s) are arranged in a rotationally symmetrical holder, in particular a cylinder, in the housing 13. By way of this it is achieved that the distance d1 or d2 after each rotation of the mirror arrangement 5 about any rotational angle is identical.

Of course it is also conceivable to rotate the mirror arrangement 5 about the optical axis 21 into several measuring positions 12 or reference positions 10. By way of the arrangement with several reference samples 9 in various reference positions 10 different types of calibrations or internal calibration of the various reference samples to one another are possible. The reference samples 9 may at the same time consist of the same or different reference materials 20. As reference materials 20 the standard reflectors usually applied for suitable light sources may be applied.

FIG. 3 shows a housing 13 with a rotatable mirror arrangement 5 of a spectrometer 1 according to the invention. The mirror arrangement 5 arranged in the inner space 22 of the housing 13 contains a first mirror 7, a second mirror 8 as well as a base 6. The mirror arrangement 5 in the region of the entry opening 4 and in the region of the exit opening 16 is rotatably mounted on in each case one lid disk 23 with mirror receivers 24. The base 6 of the mirror arrangement 5 is at the same time rigidly connected to the mirror receivers 24, e.g. via screws. On the outer side of the lid disk 23a on the entry opening 4 of the housing 13 there engages a connecting rod 25 via which the mirror arrangement 5 may be driven with the help of a motor 19 (rotation direction in the direction R).

In FIG. 4 there is shown a view of a housing 13 with a rotatable mirror arrangement 5 of a spectrometer 1 according to the invention. With this there is shown a possible drive mechanism in detail. The lid disk 23a at the entry opening 4 is rigidly connected to a connecting rod 25, e.g. via a screw. To the connecting rod via a connecting rod disk 26 there is transmitted a rotation impulse from a motor 19. The connecting rod 25 and the connecting rod disk 26 are located in the intermediate space 29. The motor 19 is fastened on an additional outer wall 30. By way of the complete separation of the drive device from the inner space 22 of the housing 13 any occurring wear, lubrication oil or other contamination is completely held away from sensitive parts such as the mirror arrangement 5 and the reference sample 9. In the arrangement shown in FIG. 4 the reference sample 9 via a lid 27 which is sealed with an O-ring is accessible from the outer side of the housing 13. By way of this the replacement of a reference sample 9 no longer capable of functioning is made possible. In normal operation the lid 27 however remains rigidly closed.

Of course other mechanisms for driving the rotatable mirror arrangement 5 than the arrangement shown in FIG. 4 are conceivable. Furthermore it is conceivable to configure the rotation mechanism such that it may be activated and programmed via software. Thus the reference measurement may be automised and may take its course in the background so that the user is largely unburdened.

Of course it is also possible to displace the mirror arrangement between the measuring sample(s) 10 and the reference sample(s) 12, in particular parallel to the optical axis of the mirror arrangement.

1. A spectrometer for reflection measurement comprising a housing and a mirror arrangement arranged in said housing for deflecting a light beam and at least one reference sample wherein the mirror arrangement is movable between at least one measuring position and at least one reference position, whereby the light beam in the measuring position is deflectable onto a measuring sample and whereby the light beam in the reference position is deflectable onto a reference sample.

2. A spectrometer according to claim 1, wherein the mirror arrangement is rotatable about the optical axis defined by an incident light beam for moving between the at least one measuring position and the at least one reference position.

3. A spectrometer according to claim 2, wherein the mirror arrangement in the measuring position is rotated by 90° with respect to the reference position.

4. A spectrometer according to claim 1, wherein the mirror arrangement and one or more reference samples are arranged in a closed housing.

5. A spectrometer according to claim 4, wherein the housing in its outer wall contains at least one receiving location for receiving a measuring sample.

6. A spectrometer according to claim 2, wherein the distance d1 from the optical axis of the mirror arrangement to the measuring sample and the distance d2 from the optical axis of the mirror arrangement to the reference sample are identical.

7. A spectrometer according to claim 1, wherein the spectrometer contains a NIR light source.

8. A spectrometer according to claim 1, wherein the spectrometer contains a UV/VIS light source.

9. A spectrometer according to claim 1, wherein the spectrometer comprises a standard reference sample and at least one further reference sample for referencing the standard reference sample.

10. A spectrometer according to claim 1, wherein the reference material for the reference samples is selected from the group of spectralon, KBr powder, TiO₂ powder, salts of rare earths, polystyrene or plexiglass.

11. A method for referencing a spectrometer in reflection measurement with a mirror arrangement for deflecting a light beam and at least one reference sample, comprising the step of moving the mirror arrangement for referencing into a reference position and determining a reference spectrum with the light beam deflected onto a reference sample.

12. A method according to claim 11, wherein the mirror arrangement for moving into the reference position is rotated about the optical axis defined by the incident light beam.

13. A method according to claim 11, wherein the movement, in the mirror arrangement is carried out automatically at a predeterminable moment.

14. A method according to claim 11, wherein before each measurement of a measuring sample automatically a reference measurement is carried out.

15. A method according to claim 11, wherein the mirror arrangement is rotated between the measuring position and the reference position about 90°.
